(19) United States
(12) Patent Application Publication
(10) Pub. No.: US 2025/0196269 A1
(43) Pub. Date: Jun. 19, 2025

(54) Controlled Foam Compressibility Using Constant Wall Thickness Between Cells

(71) Applicant: Samsung Electronics Co., Ltd., Suwon-si (KR)

(72) Inventors: Shafae Ali, Mountain View, CA (US); Forrest Tran, Milpitas, CA (US); Ziwen Jiang, Sunnyvale, CA (US); Lin Sun, Sunnyvale, CA (US); John Novak, Santa Clara, CA (US); Matthew Buchholz, Rolling Hills Estates, CA (US); Eunseo Cho, Mountain View, CA (US); Nigel Clarke, Sunnyvale, CA (US); Ivan France, Saratoga, CA (US)

(21) Appl. No.: 18/541,413

(22) Filed: Dec. 15, 2023

(51) Int. Cl. B23K 26/40; B26F 1/26

(52) U.S. Cl. CPC B23K 26/40; B26F 1/26

(57) ABSTRACT

In one embodiment, a method of manufacturing a foam material includes generating a two-dimensional surface enclosed by one or more boundaries and populating the two-dimensional surface with a number of points. The method further includes generating, for each of the number of points, a corresponding cell region on the two-dimensional surface, where each cell region has a cell surface area bounded by a cell wall, and where each cell wall has the same thickness. The method further includes generating, for each of the one or more surface boundaries, a boundary wall having a particular boundary-wall thickness; applying the two-dimensional surface to a foam material; and creating, in the foam material, cells in accordance with the cell regions within the two-dimensional surface.

### TECHNICAL FIELD

This application generally relates to compressible foam.

### BACKGROUND

Foams are formed by a material (e.g., an elastomer) in a solid phase and a material (e.g., air) in a gas phase. Foams are typically made through a reaction of multiple chemicals (e.g. polyols and diisocyanates). The solid phase may be an elastomer while the gas phase may be introduced by a blowing agent, causing cells to be produced within the material.

In bulk form foams often have a relatively limited compressibility, which refers to a force's ability to compress the foam. To increase the compressibility of foam, e.g., so that more compression occurs for a given applied force, two approaches can be taken: (1) change the material(s) used in the foam or (2) change the geometry of the foam. An example of a test used to evaluate the compressibility of foam is the Indentation Force Deflection Test, which measures the force required to compress the foam by 25% of its original thickness in a fixed sample size (e.g., in a sample of foam having dimensions of 500 mm by 500 mm by 100 mm).

### BRIEF DESCRIPTION OF THE DRAWINGS

FIG. 1 illustrates example cross sections of foams that have certain structural deficiencies.

FIG. 2 illustrates examples of foams with constant wall width between cells.

FIG. 3 illustrates an example process for making example foams described herein.

FIG. 4 illustrates an example of step 305 of the example process of FIG. 3.

FIG. 5 illustrates an example embodiment in which a foam product is used as a compressive layer of a robotic end effector.

FIG. 6 illustrates an example computer system.

### DESCRIPTION OF EXAMPLE EMBODIMENTS

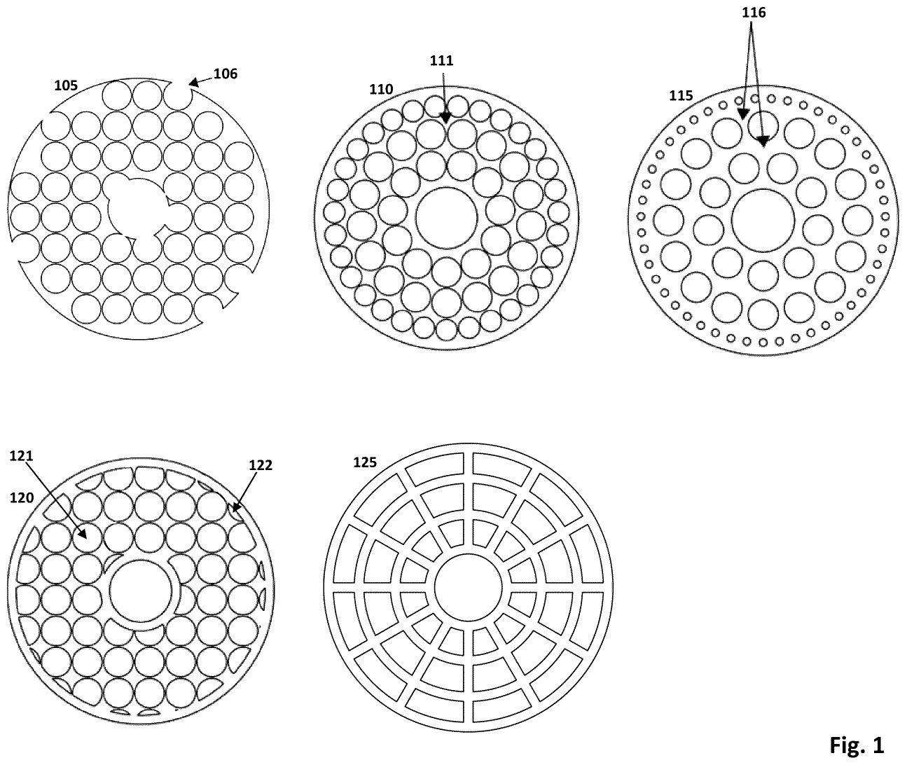

Removing solid material from a foam can increase its compressibility by creating cells of gas material, but such removal often introduces structural deficiencies to the foam. FIG. 1 illustrates example cross sections of foams that have certain structural deficiencies. For example, cross section 105 illustrates an example in which some of the circular cells in the foam intersect with interior or exterior boundaries of the foam, as illustrated by example 106, in which a circular cell intersects with the exterior edge of the foam. This makes the foam, for example, less durable at those areas in which the cells intersect with the foam boundaries. Cross section 110 illustrates an example in which cells consisting of concentric circles have been closely packed into the foam and in which no cells intersect with the edges of the foam. However, cross section 110 has a variable foam-wall thickness 111 between cells, resulting in uneven compressibility and creating reduced durability in regions of thin foam-wall thickness (e.g., due to relatively higher stress concentrations at relatively thinner walls). Such areas of thin wall thickness also create complications with common manufacturing techniques for creating the foam; for example, during laser cutting, thin walls have a relatively higher risk being melted, and during die cutting thin walls can break more easily.

Cross section 115 illustrates a foam that contains circular cells of various sizes. In this example, the inconsistent wall thicknesses 116 creates uneven compressibility and durability in the foam walls. Cross section 120 illustrates an example in which a rectilinear circular pattern of cells leaves a relatively consistent thickness at the outer and inner edges of the foam, but results in uneven foam-wall thickness in the interior of the foam and results in large deviation in cell surface area (e.g., compare cells 121 and 122), creating uneven compressibility across the foam. Cross section 125 illustrates an example in which the cells are radially distributed through the foam, resulting in relatively even foam-wall thickness between cells. However, the cells in cross section 125 have uneven surface area, and the geometric pattern illustrated in cross section 125 is suitable only for a circularly-shaped foam cross section. As a result, using the pattern of cross section 125 for any other shape would result in uneven wall thickness, among other deficiencies.

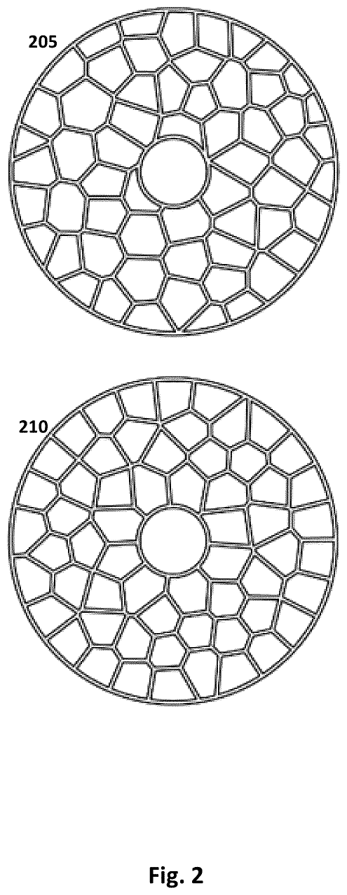

In contrast to the foams illustrated in FIG. 1, FIG. 2 illustrates examples of foams with constant wall width between cells and, in the examples of FIG. 2, the wall width between cells is also the width of the boundaries of the foam. Cross section 205 illustrates an example of a foam with constant wall width and a random cell distribution structure, i.e., the cells are not evenly sized within the foam. Cross section 210 illustrates an example of a foam with constant wall width and an even cell distribution, i.e., the cells in cross section 210 are evenly distributed within the foam, up to a certain tolerance. For instance, in the example of FIG. 2, the surface areas of the cells in cross section 210 have a standard deviation of 15% of the mean cell surface area. This disclosure contemplates that more or less restrictive tolerances may be used, and that other types of tolerance measures (e.g., a permitted percent variation between the largest and smallest cell surface area, etc.) may be used to define an acceptable cell distribution.

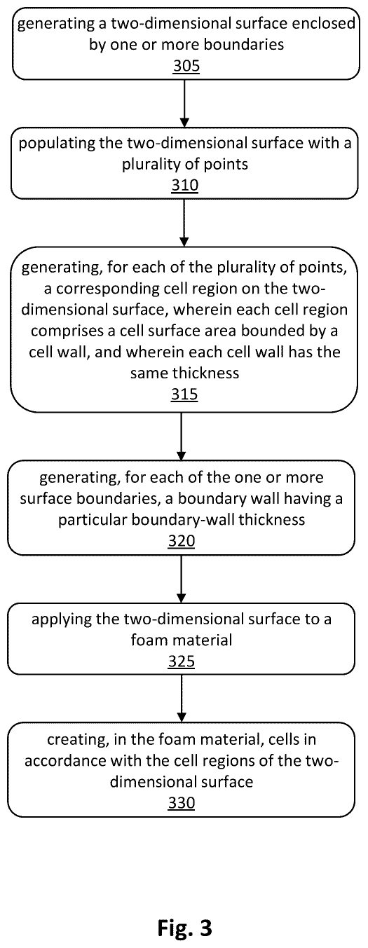

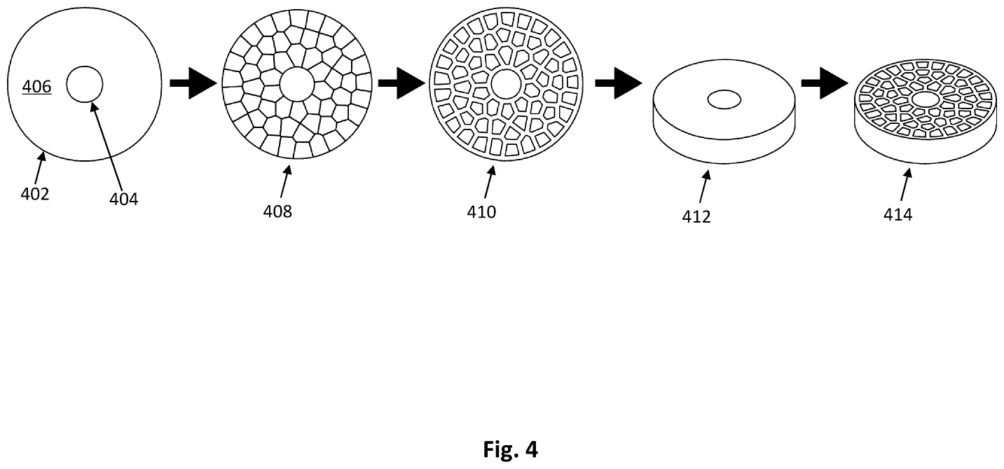

FIG. 3 illustrates an example process for making example foams described herein, such as the example foams of FIG. 2. As explained below, certain steps of the example method of FIG. 3 may be performed on a computing device, and certain other steps may be performed on a foam product. Step 305 of the example process of FIG. 3 includes generating a two-dimensional surface enclosed by one or more boundaries. FIG. 4 illustrates an example of step 305 in which an outer boundary 402 and an inner boundary 404 are generated for a particular two-dimensional surface 406. In the example of FIG. 4 two-dimensional surface 406 is a circular shape, but the example method of FIG. 3 can be applied to a two-dimensional surface of any shape, including irregular shapes. In particular embodiments, an outer boundary and an inner boundary of a two-dimensional surface need not have the same shape. Moreover, in particular embodiment, step 305 may include defining only an outer boundary, or may include defining additional inner boundaries in a two-dimensional surface.

Once the boundary or boundaries are generated in step 305, subsequent steps of the example process of FIG. 3 operate on the closed surface defined by the boundary or boundaries generated in step 305. Step 310 of the example method of FIG. 3 includes populating the bounded two-dimensional surface with a plurality of points. In particular embodiments, the locations of the points on the two-dimensional surface may be randomly determined, in that the points are placed at random. In particular embodiments, the number of points to use to populate a surface depends on the number of cell regions that are desired on a resulting foam. For example, each point may eventually correspond to a single cell in a foam product, and therefore more points may result in more cells being created in a resulting foam product for a given surface. In particular embodiments, the number of points to use in any given instance is based on the use case for the resulting foam, e.g., is based on the desired compressibility, durability, and weight of the resulting foam product.

In particular embodiments, step 310 may include distributing the points after the surface is populated with the points. For example, cross section 210 of FIG. 2 illustrates an example foam in which the points were evenly distributed on the surface. In contrast, cross section 205 illustrates an example in which points were not distributed after being randomly generated. In particular embodiments, a distribution of points may be based on a desired aesthetic appearance of the resulting foam, as each point will result in a cell in the foam. In particular embodiment, a distribution of points may be based on a density map of the surface to control the compressibility of the resulting foam. In particular embodiments, the points may be distributed evenly on the surface.

In particular embodiments, the approximate surface area of each resulting cell may be determined by, for example, the total available surface area of the bounded two-dimensional surface divided by the number of points that are placed in step 310. In particular embodiments, the appropriate number of points may be determined by setting the desired approximate cell surface area and dividing the total bounded surface area of the two-dimensional surface by the desired approximate cell surface area to arrive at the number of points to use to populate the surface.

Step 315 of the example method of FIG. 3 includes generating, for each of the plurality of points, a corresponding cell region on the two-dimensional surface, where each cell region has a cell surface area bounded by a cell wall, and where each cell wall has the same thickness. Cross section 408 in the example of FIG. 4 illustrates an example of step 315 in which the points were approximately evenly distributed after populating the surface. Cross section 410 in the example of FIG. 4 illustrates the cells generated in cross section 408 after the cell-wall thickness is applied to the regions between the cells. In particular embodiments, Voronoi cells may be used to generate the cell regions by portioning the surface into convex polygons. In particular embodiments, Lloyd's algorithm may be used to iteratively distribute portions of surface area such as those divided into Voronoi regions. In particular embodiments, other approaches may be used for generating the cell regions, including but not limited to Delaunay triangulation, Gabriel Graph, Pitteway triangulation, or any other suitable approach. In particular embodiments, cell walls may be straight lines (e.g., lines creating a polygonal shape) or may be curved lines (e.g., lines creating a curved planar shape), or may be a combination thereof.

In particular embodiments, steps 310 and 315 may be performed for each of a number of sub regions in the two-dimensional surface. For example, after the surface boundaries are determined in step 305, the surface within the boundary may be separated into a number of sub regions. Each sub region may be treated separately for the purposes of performing step 310 and/or step 315. For example, different sub regions can have different cellular densities, for example based on different numbers and distributions of points within different sub regions. Different sub regions may have cells of different sizes, for example by specifying a scale factor between 0 (no size) and 1 (full cell size for a given process). Different cell distributions can result in varying compressibility properties across the surface of a resulting foam product. For example, the compressibility (and cellular density) can vary radially, linearly, or in any other suitable manner across a surface of a foam product. The varying cellular density and compressibility can, in particular embodiments, be created by generating sub regions in the two-dimensional surface and varying the points and/or cell size in different sub regions.

Step 320 of the example method of FIG. 3 includes generating, for each of the one or more surface boundaries, a boundary wall having a particular boundary-wall thickness. For example, cross section 410 of the example of FIG. 4 illustrates the boundary regions having the same thickness as the cell-wall thickness determined in step 315. However, as described herein, the boundary wall thickness and the cell-wall thickness may or may not be the same. In particular embodiments, step 320 of the example process of FIG. 3 may include intersecting the generated cells with the external and internal boundaries if there is any overlap between cell regions and those boundaries. In particular embodiments, the cell-wall thickness or boundary-wall thickness, or both, may be used to control the compressibility of the resulting foam.

Step 325 of the example method of FIG. 3 includes applying the two-dimensional surface to a foam material. Foam 412 in the example of FIG. 4 illustrates applying surface 406 with defined boundaries 402 and 404 to a particular foam having a particular thickness. Thus, the cross section of foam 412 in a direction perpendicular to the foam thickness has the shape and boundaries defined in step 305 of the example process of FIG. 3.

Step 330 of the example method of FIG. 3 includes creating, in the foam material, cells in accordance with the cell regions within the two-dimensional surface. Foam 414 illustrates an example foam resulting from the application of surface cross section 410 to foam 412. The cells run through the thickness of foam 414, i.e., the top and bottom surfaces of foam 414 are identical. While in particular embodiments additive manufacturing techniques may be used in steps 325 and 330 to generate a foam product, in other embodiments subtractive processes may be used to generate a form product. For example, laser cutting or die cutting are commonly used subtractive manufacturing techniques, and the example process of FIG. 3 lends itself to such techniques. Other example subtractive manufacturing techniques include, but are not limited to, cutting by computer numerical control (CNC) routing or water jet cutting. In particular embodiments, a foam product created from the example process of FIG. 3 may be placed on a 3D surface, which may have an arbitrary shape.

The foam material used in steps 325 and 330 for a particular foam product may be any suitable type. For example, a foam may be an ultra-soft foam with an IFD 25% of 0.3 psi or 15.08 lbs (as measured using a standard 8″ indenter).

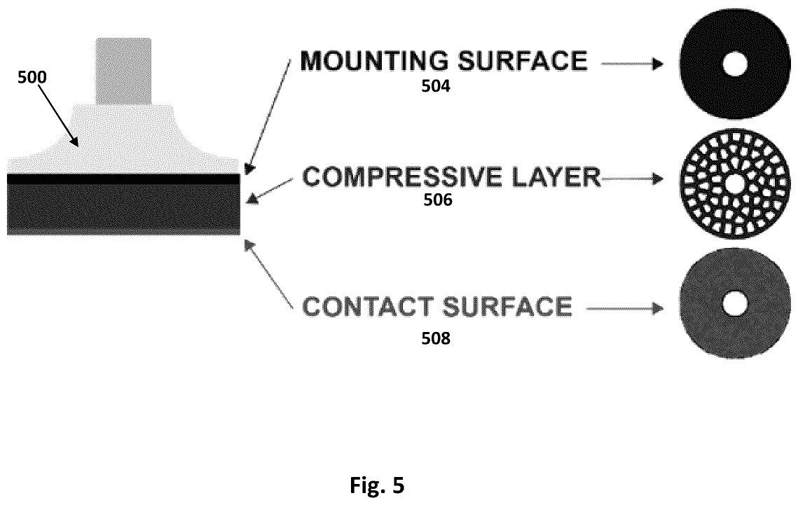

In particular embodiments, additional processing steps may be performed to manufacture a foam product. For example, corners of a cell region (e.g., of a polygonal cell region) may have a fillet to reduce stress concentrations in the foam material. In particular embodiments, the resulting foam product may be combined with other features to form a finished foam product. For example, FIG. 5 illustrates an example embodiment in which the foam product is used as a compressive layer 506 of a robotic end effector 500. The robotic end effector 500 may be used for, for example, automatically cleaning surfaces by scrubbing the surfaces through rotation of the end effector. As illustrated in FIG. 5, the foam product (i.e., compressive layer 506) is connected to the robotic end effector 500 by a mounting surface 504. The opposite end of compressive layer 506 is coupled to a contact surface 508, which is used to contact surfaces for cleaning by robotic end effector 500. Enclosing the foam product between two other surfaces, such as is illustrated in FIG. 5, can help prevent debris from collecting inside the cell regions of the foam product and can help distribute force across the entire face of the compressive foam layer rather than having a localized compressive force be localized on particular cell walls that happen to contact the object providing the compressive force. This ensures that the foam product provides a consistent compressibility.

A mounting surface, such as mounting surface 504 of the example of FIG. 5, can be used to protect the face of the compressive layer (i.e., the foam layer) and can constrain the movement of the compressive layer in the plane of the layer. In particular embodiments, a compressive layer can be free-floating or fixed to the mounting surface either mechanically (such as by using e.g. screws, friction-based, hook and loop fasteners, etc.) or chemically (such as by using adhesives, solvent, etc.). A contact surface, such as contact surface 508 of the example of FIG. 5, can be used to protect the face of the compressive layer from contact with external objects, and can constrain the movement of the compressive layer in the plane of the layer. The compressive layer can be free-floating or fixed to the contact surface mechanically (such as by using e.g. screws, friction-based, hook and loop fasteners, etc.) or chemically (such as by using adhesives, solvent, etc.).

In the example of FIG. 5, robotic end effector 500 may be attached to the end of a robotic cleaning system, such as a mobile robot that carries end effector 500 for wiping surfaces. The robotic cleaning system may have environmental sensors, e.g., a camera, for detecting and imaging a surface to clean. As the robotic cleaning system's detection and mapping will not perfectly correspond to the real surface, the end effector may inadvertently press into the surface, pushing the robotic system back and disrupting the cleaning process. However, the foam product made according to the example process of FIG. 3 results in a foam that is both durable and much more compressible than the bulk foam, and with a compressibility that is controllably manufacturable. Thus, in the example use case of FIG. 5, the increased compressibility results in the foam compressing when inadvertently pushed into the surface, reducing or eliminating the resultant push-back of the robotic cleaning system.

While FIG. 5 illustrates an example of a foam product in an end effector of a robotic cleaning device, this disclosure contemplates that a foam product described herein, such as a foam made from the example process of FIG. 3, made be used in any other suitable application such as in chairs, handles, headphone cushions, beds, shoe insoles, or in any other suitable product for a which a foam is required, particularly a relatively low-cost foam, as the processes described herein result in a foam with controllable compressibility using existing, standardized manufacturing techniques (e.g., subtractive manufacturing).

In particular embodiments, some or all volumes of cell regions in a foam may be partially or completely filled with one or more materials. For example, some or all cell regions may be filled to alter the foam's properties, such as durability, compressibility, and other factors. In particular embodiments, one or more sensors may be placed within cell regions.

In particular embodiments, multiple identical or non-identical foam pieces may be layered on top of each other to increase the total thickness of a foam product and/or to control that product's properties. In particular embodiments, two or more foam pieces in a stack of foam pieces may have different properties, such as different thicknesses, different cell regions in number or in shape (or both), different foam materials, etc.

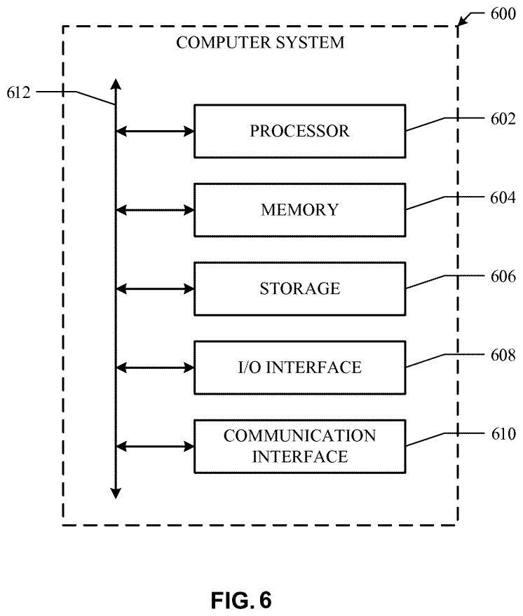

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 1 occurring in any suitable order. Moreover, although this disclosure describes and illustrates particular components, devices, or systems carrying out certain steps of the method of FIG. 3, such as the computer system of FIG. 6, this disclosure contemplates any suitable combination of any suitable components, devices, or systems carrying out any suitable steps of the method of FIG. 3. Moreover, this disclosure contemplates that some or all of the computing operations described herein, including certain steps of the example method illustrated in FIG. 3, may be performed by circuitry of a computing device, for example the computing device of FIG. 6, by a processor coupled to non-transitory computer readable storage media, or any suitable combination thereof.

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method of manufacturing a foam material comprising:
generating a two-dimensional surface enclosed by one or more boundaries;
populating the two-dimensional surface with a plurality of points;
generating, for each of the plurality of points, a corresponding cell region on the two-dimensional surface, wherein each cell region comprises a cell surface area bounded by a cell wall, and wherein each cell wall has the same thickness;
generating, for each of the one or more surface boundaries, a boundary wall having a particular boundary-wall thickness;
applying the two-dimensional surface to a foam material; and
creating, in the foam material, cells in accordance with the cell regions within the two-dimensional surface.

2. The method of claim 1, wherein populating the two-dimensional surface with the plurality of points comprises one or more of:
evenly distributing the plurality of points on the two-dimensional surface; or
distributing the points according to a point density map based on a target compressibility for the foam material.

3. The method of claim 2, wherein a metric describing a variation in the cell surface area among cell regions in the surface is less than a threshold tolerance.

4. The method of claim 1, wherein the cell-wall thickness and the boundary-wall thickness are the same thickness.

5. The method of claim 1, wherein each cell region comprises one or more of a polygonal shape or a curved planar shape.

6. The method of claim 1, wherein generating cells in the foam material comprises removing material from the foam.

7. The method of claim 6, wherein removing material from the foam comprises one or more of: (1) die cutting the foam material; (2) laser cutting the foam material; (3) CNC routing the foam material; or (4) water jet cutting the foam material.

8. The method of claim 1, wherein the foam material comprises a plurality of foam materials.

9. The method of claim 1, further comprising enclosing the foam material between (1) a mounting surface adjacent to a first surface of the foam material and (2) a contact surface adjacent to a second surface of the foam material opposite the first surface.

10. A foam product created by a process comprising:
generating a two-dimensional surface enclosed by one or more boundaries;
populating the two-dimensional surface with a plurality of points;
generating, for each of the plurality of points, a corresponding cell region on the two-dimensional surface, wherein each cell region comprises a cell surface area bounded by a cell wall, and wherein each cell wall has the same thickness;
generating, for each of the one or more surface boundaries, a boundary wall having a particular boundary-wall thickness;
applying the two-dimensional surface to a foam material; and
creating, in the foam material, cells in accordance with the cell regions within the two-dimensional surface.

11. The foam product of claim 10, wherein populating the two-dimensional surface with the plurality of points comprises one or more of:
evenly distributing the plurality of points on the two-dimensional surface; or
distributing the points according to a point density map based on a target compressibility for the foam material.

12. The foam product of claim 11, wherein a metric describing a variation in the cell surface area among cell regions in the surface is less than a threshold tolerance.

13. The foam product of claim 10, wherein the cell-wall thickness and the boundary-wall thickness are the same thickness.

14. The foam product of claim 10, wherein each cell region comprises one or more of a polygonal shape or a curved planar shape.

15. The foam product of claim 10, wherein generating cells in the foam material comprises removing material from the foam.

16. The foam product of claim 10, wherein the process further comprises enclosing the foam material between (1) a mounting surface adjacent to a first surface of the foam material and (2) a contact surface adjacent to a second surface of the foam material opposite the first surface.

17. An apparatus comprising:
a foam material comprising:
one or more boundary walls, each having a particular boundary-wall thickness; and
a region within the one or more boundary walls comprising a plurality of cells, each cell surrounded by a cell wall, each cell wall in the region having the same thickness;
a mounting surface adjacent to a first surface of the foam material; and
a contact surface adjacent to a second surface of the foam material opposite the first surface.

18. The apparatus of claim 17, wherein a metric describing a variation in a cell surface area among cells is less than a threshold tolerance.

19. The apparatus of claim 17, wherein the cell-wall thickness and the boundary-wall thickness are the same thickness.

20. The apparatus of claim 17, wherein each cell comprises one or more of a polygonal shape or a curved planar shape.
